(19) United States
(12) Patent Application Publication
(10) Pub. No.: US 2012/0096515 A1
(43) Pub. Date: Apr. 19, 2012

(54) METHOD AND APPLICATION FOR THE PARENTAL CONTROL OF THE USE OF A TERMINAL

(76) Inventors: Mounir Soudani, Nozay (FR); Jean-Roch Houllier, Saint-Michel Sur Orge (FR)

(21) Appl. No.: 13/376,419

(22) PCT Filed: May 6, 2010
(86) PCT No.: PCT/FR2010/050867

§ 371 Date: Jan. 3, 2012

(30) Foreign Application Priority Data
Jun. 11, 2009 (FR) 0902855

(51) Int. Cl. G06F 17/00

(52) U.S. Cl. 726/1

(57) ABSTRACT

The invention pertains to a method for the parental control of a terminal's usage, wherein said terminal's usage rules are configured beforehand, said rules being applied in order to allow or deny access to a service requested by the user by means of said terminal, said method further providing to determine events for which the user may be rewarded, and, if one of said events occurs, to define a usage reward (R) corresponding to said event, said reward being subject to parental approval prior to its being taken into account in the application of the usage rules. The invention also pertains to an application for the parental control of a terminal's usage.

The invention pertains to a method for the parental control of the use of a terminal, as well as an application for the parental control of the use of a terminal.

In particular, the invention applies to a mobile telecommunication terminal, said terminal being used by a child whose parents wish to exercise control over said usage, particularly with respect to access to telephone calls, but also to other services available by means of a mobile telephone.

In order to do so applications are known which enable parents to configure the usage rules of their child's terminal, said rules being applied in order to allow or deny access to a service requested by the child by means of his or her terminal.

Furthermore, known applications make it possible to notify parents of some information related to applying the usage rules, particularly by transmitting:
alert notifications whenever a usage limit is approaching;
notifications that a usage credit has been depleted;
notifications of denying access to a service requested by the child by means of his or her telephone.

In particular, the application known as “Alcatel-Lucent 8611 Usage Control” allows the parent to control the use of their child's mobile telephone.

However, this type of application is limited to purely controlling the use of the terminal by the child. Furthermore, whenever the parents wish to change the usage rules, including temporarily based on a particular event, they must repeat the configuration of said rules manually using the interface available for that purpose, for example a web portal of the mobile telecommunication operator, which may involve a time constraint.

The purpose of the invention is to remedy the shortcomings of the prior art, particularly by proposing a parental control method whose flexibility may automatically be improved, particularly with respect to the occurrence of particular events.

For that purpose, and according to a first aspect, the invention proposes a method for the parental control of the use of a terminal, in which said terminal's usage rules are configured beforehand, said rules being applied in order to allow or deny access to a service requested by the user by means of said terminal, said method further providing to determine events for which the user may be rewarded, and, if one of said events occurs, to define a usage reward corresponding to said event, said reward being subject to parental approval prior to its being taken into account in the application of the usage rules.

According to a second aspect, the invention proposes an application for the parental control of a terminal's usage, said application incorporating an access control system comprising a module for configuring usage rules of said terminal and a control module that is configured to apply said rules in order to allow or deny access to a service requested by the user of said terminal, said application further incorporating a reward system comprising a module for determining events for which the user may be rewarded, a module for establishing that such an event has occurred, a module for defining a usage reward corresponding to said event, a parental approval module for said reward, and a module for taking said granted reward into account in the control module.

Other features and advantages of the invention will become apparent in the following description, written in connection with the attached figures, in which:

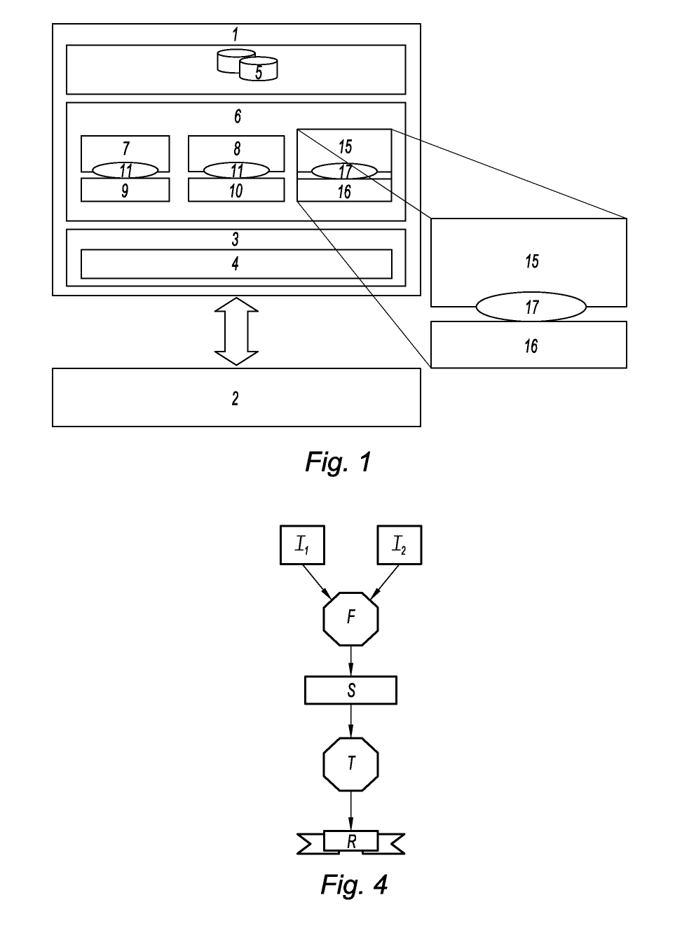

FIG. 1 depicts an architecture comprising an application for implementing a parental control method according to one embodiment of the invention;

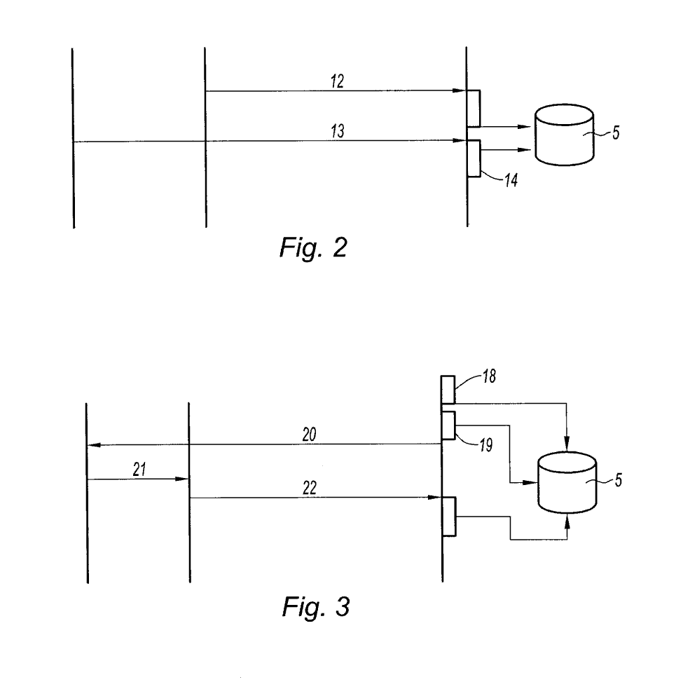

FIG. 2 represents the configuration and application of the usage rules in order to allow or deny access to a service requested by the user by means of his or her terminal;

FIG. 3 represents the determination and occurrence of an event, as well the submission of a reward for parental approval prior to its being taken into account in the application of the usage rules;

FIG. 4 represents the definition of a reward established based on a score that is a function of two of the terminal's usage indicators.

Below is described a method and application for the parental control of the usage of a child's terminal, particularly a mobile telephone. In particular, the control is performed based on the child's mobile telephone number (or MSISDN for Mobile Subscriber Integrated Services Digital Network Number). Thus, if the child changes telephones and keeps the same telephone number, the parental control continues to apply.

In FIG. 1, the application is depicted in a server 1 architecture, said server communicating with a system 2 of the telephony operator in which the parental control service is loaded. To do so, the server 1 exhibits a management protocol 3 and an input/output interface manager 4 between the server 1 and the system 2.

The application server 1 also exhibits databases 5 and an application container 6 comprising a control system 7 for accessing telephone calls as well as Internet services, and a system 8 used to specify the control rules, for example from a web interface.

Each of these access control systems 7, 8 communicate with the service in question, i.e. respectively with a container 9 of the telecommunication service and with a Web server 10, by means of a programming interface 11 (an API, for Application Programming Interface).

The access control systems 7, 8 make it possible to implement the parental control by providing that the usage rules be configured beforehand by the parents for their child's mobile terminal. To do so, the control systems 7, 8 may comprise a configuration module for said terminal's usage rules, for example providing the parents with a graphical interface (a GUI, for Graphical User Interface).

In example embodiments, usage rules may be configured to define:
a reduced activity, for example, the child is not permitted to call during school hours;
a prohibited service, for example prohibited telephone numbers;
a usage limitation based on at least one service unit, for example a communication time, a number of SMS or MMS messages, or a volume of data;
a usage limitation based on a cost, for example in Euros;
a service that is always allowed, for example emergency telephone numbers.

In connection with FIG. 2, the parents configure or modify 12 the usage rules that are stored in the databases 5. Afterward, whenever access to a service is requested 13 by the terminal's user, the usage rules are applied 14 in order to allow or deny access to said service, for example by means of a control module for each control system 7, 8.

In connection with FIG. 1, the application also incorporates a reward system 15 that communicates with the container 16 of the telecommunication service by means of a programming interface 17.

The reward service comprises a module for determining events for which the user may be rewarded, a module for establishing that such an event has occurred, a module for defining a user reward corresponding to said event, a parental approval module preset reward, and a module for taking said granted reward into account within the control module.

Thus, the parental control method enables parents in particular to initially determine events for which the child may be rewarded. Afterward, the occurrence of one of said events may be automatically established in order to be able to define, also automatically, a usage reward corresponding to said event.

In particular, a reward may correspond to a loosening or removal of at least one restriction that resulted from applying at least one usage rule, said reward potentially being preconfigured by the parents or defined by the application.

The method provides that the defined reward be subject to parental approval prior to its being taken into account in applying the usage rules. In particular, the defined reward may be submitted by notification to a terminal of the parent, with the parental approval being established through a positive response to said notification. In this case, the rules associated with the child are automatically updated without any need for the parent to use the system 8. Likewise, the taking into account of the reward may be notified on the user's terminal.

In connection with FIG. 3, after determining and recording 18 events in the databases 5, the occurrence 19 of an event leads to the notification 20 the parents, for example by SMS, of a usage reward corresponding to said event.

Next, parental approval 21 may be established by a positive response to the notification SMS, in order to be able to take into account 22 the reward in applying the usage rules.

In a first example embodiment, at least one event may be determined temporally, for example in the form of a date corresponding to the child's birthday. Thus, on that date, for example, terminal usage bonuses may be granted to the child.

In a second example embodiment, at least one event may be determined as a function of the usage, particularly good usage in accordance with the rules, of the terminal by the child, the method providing that said usage be monitored in order to establish that such an event has occurred.

In particular, the method may comprise the establishment of a score as a function of at least one usage indicator, the monitoring of an event corresponding to the establishment of a target score. To do so, the module for establishing that an event has occurred comprises means for monitoring the terminal's usage, means for calculating a score as a function of at least one usage indicator, and means for establishing an event whenever a target score is calculated.

For example, a usage indicator may depend on compliance with the usage rules and/or depend on at least one parameter used within said rules.

In connection with FIG. 4, below is described the definition of a reward established on the basis of a score that depends on the following two usage indicators:
An indicator that depends on complying with the usage rules: I₁=(total number of denials)/(total number of authorizations);
Usage indicator: I₂=(units consumed)/(total number of units authorized).

Based on these two indicators, the score calculation function F may be chosen by the operator and/or by the parents, particularly in the event determination module, so as to establish a score S. In the example above, the best score is calculated when I₁=0 and I₂=1. These scores, as well as the indicators that correspond to them, maybe redefined any time within the meaning of the configuration data that they represent.

Next, the means for establishing an event may comprise a lookup table T between a target score and a reward, so as to establish the reward R to be submitted to the parents.

1. A method for parental control of usage of a terminal, wherein usage rules of the terminal are configured beforehand, the usage rules being applied in order to allow or deny access to a service requested by a user by means of the terminal, the method comprising the steps of:
determining events for which the user may be rewarded, and
defining a usage reward corresponding to the events if one of the events occurs, the usage reward being subject to parental approval prior to the usage reward being taken into account in applying the usage rules.

2. The method according to claim 1, further comprising the step of determining at least one event temporally.

3. The method according to claim 1, further comprising the steps of:
determining at least one event as a function of the usage of the terminal, and
monitoring the usage of the terminal in order to establish that the event has occurred.

4. The method according to claim 3, further comprising the step of establishing a score as a function of at least one usage indicator, the occurrence of the event corresponding to an establishment of a target score.

5. The method according to claim 4, wherein a usage indicator depends on compliance with the usage rules and/or depends on at least one parameter used within the usage rules.

6. The method according to claim 1, further comprising the step of submitting the usage reward by notification to a terminal of the parent, with parental approval being established by a positive response to the notification.

7. The method according to claim 1, wherein the usage reward corresponds to a loosening or removal of at least one restriction that resulted from applying at least one usage rule.

8. The method according to claim 1, further comprising the step of notifying the taking into account of the usage reward on the user's terminal.

9. An application server configured to provide parental control of a terminal's usage, the application server comprising:
an access control system to configure usage rules of the terminal and apply the usage rules in order to allow or deny access to a service requested by a user of the terminal, and
a reward system configured to
determine events for which the user may be rewarded,
establish that such an event has occurred,
define a usage reward corresponding to the event, and
allow parental approval for the usage reward.

10. The application server according to claim 9, further comprising:
means for monitoring the terminal's usage,
means for calculating a score as a function of at least one usage indicator, and
means for establishing an event whenever a target score is calculated.
